(19) United States
(12) Patent Application Publication
(10) Pub. No.: US 2026/0338009 A1
(43) Pub. Date: Oct. 29, 2026

(54) Vehicle Door for a Motor Vehicle, in Particular for a Passenger Motor Vehicle, and Motor Vehicle

(71) Applicant: Bayerische Motoren Werke Aktiengesellschaft, Muenchen (DE)

(72) Inventors: Steve BREUNINGER, Gauting (DE); Jacobo DOMINGUEZ OJEA, Muenchen (DE); Alexander SCHNEIDER, Muenchen (DE)

(21) Appl. No.: 19/113,504

(22) PCT Filed: Oct. 13, 2023
(86) PCT No.: PCT/EP2023/078465

§ 371 Date: Mar. 20, 2025

(30) Foreign Application Priority Data
Oct. 19, 2022 (DE) 10 2022 127 596.5

(51) Int. Cl. E05B 81/76; E05B 81/78; E05B 85/10

(52) U.S. Cl. CPC E05B 81/77; E05B 81/78; E05B 85/10

(57) ABSTRACT

A vehicle door comprising a handle element arranged on the outside of the door, wherein at least one control element for electrically locking and/or unlocking a lock is integrated into the handle element, by way of which lock the vehicle door can be secured in the closed position. Alternatively or in addition, at least one gesture sensor is integrated into the handle element to detect at least one gesture made by a person. Alternatively or in addition, at least one speech recognition sensor is integrated into the handle element to detect at least one speech command spoken by a person. Alternatively or in addition, at least one near-field communication sensor is integrated into the handle element.

### BACKGROUND AND SUMMARY

This disclosure relates to a vehicle door for a motor vehicle, in particular for a passenger motor vehicle. The disclosure also relates to a motor vehicle, in particular a passenger motor vehicle, with at least one such vehicle door.

WO 2007/118552 A1 discloses a motor vehicle with a vehicle door having a lower door part and an upper window part separated by a window sill. WO 2020/01137 A1 discloses a device for actuating a vehicle door of a vehicle, with a sensor apparatus that is configured to detect a force acting on the vehicle door and to generate corresponding sensor data. Furthermore, DE 10 2017 202 114 A1 discloses a motor vehicle with at least one side door that has a door body. Furthermore, WO 2006/007916 A1 discloses a motor vehicle door with an inner module and an outer module. Moreover, DE 10 2010 101 164 A1 discloses a door handle unit for actuating a lock of a door or a flap.

An object of the present disclosure is to provide a vehicle door for a motor vehicle, in particular a passenger motor vehicle, and a motor vehicle, so that particularly advantageous operation can be realized.

A first aspect of the disclosure relates to a vehicle door, also referred to simply as a door and formed, for example, as a side door, for a motor vehicle, preferably formed as a passenger motor vehicle and also referred to as a vehicle or motor vehicle. This means that the motor vehicle, also referred to as a motor vehicle or vehicle, whose interior, also referred to as the passenger cabin or passenger compartment, is formed, for example, by a structure of the motor vehicle formed, in particular, as a self-supporting body, has the structure and the vehicle door in its fully manufactured state. The vehicle door has a handle element on the outside of the door, which, in particular in the installation position of the vehicle door, which assumes its installation position when the motor vehicle is completely assembled, is arranged in the vehicle vertical direction of the motor vehicle above a door sill of the vehicle door. The handle element is also referred to as an outer handle or outer door handle. In the fully manufactured state of the motor vehicle, the vehicle door is held movably, in particular pivotably, on the structure, so that the vehicle door can be arranged or is arranged, i.e. is to be held or is held, on the structure in a movable, in particular pivotable, manner. In particular, the vehicle door is assigned a structure opening of the structure, the structure opening of which is in particular a door opening. If the vehicle door is a side door, the door opening is a lateral door opening which, for example, is arranged on a left or right side of the structure or of the motor vehicle, viewed in the vehicle transverse direction of the motor vehicle. The vehicle door can be moved, in particular pivoted, relative to the structure between a closed position and at least one open position. In the closed position, at least a sub-region of the structure opening is closed by the vehicle door. In the open position, the vehicle door releases the sub-region of the structure opening, so that, for example, when the vehicle door is open, a person can enter or exit the interior via the released sub-region of the structure opening. In particular, it is provided that the handle element is arranged above the door sill in the installation position of the vehicle door and in relation to the closed position of the vehicle door in the vehicle vertical direction of the motor vehicle. The door sill is also simply referred to as a sill or window sill or edge or kerb, or the door sill is formed by a kerb or coincides with the kerb. In particular, the door sill is or forms an edge, in particular a lower edge, by which, for example, a windowpane opening, also referred to as a window opening, for a windowpane, in particular for a side windowpane, of the vehicle door is at least partially limited, in particular in the installation position of the vehicle door and in relation to the closed position of the vehicle door in the vehicle vertical direction of the motor vehicle downward.

For example, a person in the vicinity of the motor vehicle and thus the vehicle door can grasp the handle element with their hand and, for example, at least partially grasp around it and, for example, subsequently exert a force on the handle element and thus on the vehicle door via the handle element in order to thereby handle the vehicle door, i.e. in particular to be able to move it relative to the structure, in particular to pivot it. For example, the person can exert such a force on the vehicle door via the handle element that the vehicle door is opened by the force, thus moving it from the closed position to the open position relative to the structure. Furthermore, for example, the person in the vicinity can exert such a force on the handle element and thus on the vehicle door that the vehicle door is closed by the force, thus moving from the open position to the closed position. The feature that the handle element is arranged on the outside of the door or on the outside, thus being an outside handle element or a handle element on the outside of the door and thus an outer door handle, is to be understood as meaning that handle element is arranged on an outside of the vehicle door, the outside of which faces away from the interior and toward the sunroundings in the installation position of the vehicle door and at least in the closed position of the vehicle door.

In order thus to be able to realize particularly advantageous operation, i.e. actuation, of the vehicle door in particular via the handle element, it is provided according to the disclosure that at least one operating element for electrically locking and/or unlocking a lock, also referred to as a door lock, is integrated into the handle element, wherein the vehicle door, which can be arranged on the structure of the motor vehicle so as to be movable between the closed position and the open position, is to be secured in the closed position by way of the lock. In principle, it would be conceivable for the operating element to be held on the handle element or to be a component of the handle element. In particular, it is conceivable for the operating element to be held on a base of the handle element, wherein it is conceivable for the operating element to be formed separately from the base. The operating element can be held immovably or movably, in particular pivotably, on the base or on the handle element. By way of the operating element, the lock, also referred to as a door lock, by way of which the vehicle door, which can be arranged or is arranged on the structure of the motor vehicle in a movable, in particular pivotable, manner between the closed position and the at least one open position, is to be secured in the closed position, in particular relative to the structure, can be electrically unlocked and/or electrically locked. In order to thus open the vehicle door, which is initially in the closed position and thus closed and secured in the closed position by way of the lock, in particular relative to the structure, for example, the person in the vicinity operates, in particular actuates, the operating element, as a result of which the lock is, for example, electrically unlocked, i.e. as a result of which an electrical unlocking of the lock is brought about. In particular, the person touches the operating element. It is furthermore conceivable that, for example, the lock is electrically locked by way of the operating element, in particular after the vehicle door has been closed, as a result of which the vehicle door is secured in the closed position relative to the structure. To lock the lock, for example, the aforementioned person in the vicinity operates, in particular touches, the operating element, in particular while the vehicle door is in the closed position.

By way of the lock, the vehicle door, which can be arranged or is arranged on the structure of the vehicle (motor vehicle) so as to be movable, in particular pivotable, between the closed position and the at least one open position, is to be secured or is secured in the closed position, in particular relative to the structure, so that an undesired movement of the vehicle door from the closed position to the open position is prevented. By unlocking the lock, the lock releases the vehicle door for movement from the closed position to the open position. In particular, the lock can be a component of the vehicle door, so that the lock can be moved, in particular pivoted, in the vehicle door relative to the structure between the closed position and the open position. The lock can be adjusted, for example, between a locked state and an unlocked state. By unlocking the lock, the lock is moved, i.e. transferred, from the locked state to the unlocked state. By locking the lock, the lock is moved, i.e. transferred, from the unlocked state to the locked state. For example, if the vehicle door is in the closed position and the lock is in the locked state at the same time, the vehicle door is secured by way of the lock in the closed position, for example, and thus against undesirable movement relative to the structure into the open position. It is apparent that the vehicle door is a wing element which can be arranged or is arranged on the structure so as to be movable, in particular pivotable, between the open position and the closed position. The vehicle door (wing element) is in particular an attachment part which is formed separately from the structure and which is to be held or is held on the structure so as to be movable between the open position and the closed position. In order, for example, to open the vehicle door, which is initially closed and thus initially in the closed position, and thus to move it from the closed position to the open position, the operating element is operated, in particular actuated, by the person in the surroundings. By operating, in particular actuating, the operating element, the lock is electrically unlocked, thus electrically transferred from the locked state to the unlocked state, so that the lock releases the vehicle door for a movement relative to the structure from the closed position to the open position. Alternatively or additionally, the lock can be locked, for example, by operating, in particular actuating, the operating element, in particular while the vehicle door is in the closed position. For example, a locking element such as, for example, a closing bolt, also referred to as a lock bolt, or a lock bracket, also referred to as a closing bracket, is attached to the structure, in particular to a vehicle pillar of the structure, for example, formed as a door pillar and also referred to as a body or structure pillar. In the closed position of the vehicle door and in the locked state of the lock, for example, the lock, in particular a fork latch of the lock, interacts with the locking element, in particular in a form-fitting manner, as a result of which the vehicle door is to be secured or is secured in the closed position in a form-fitting manner. For example, the lock has a lock element, which can be, for example, the aforementioned fork latch. In the closed position of the vehicle door and in the locked state of the lock, for example, the lock element interacts with the locking element, in particular in a form-fitting manner, as a result of which the vehicle door is to be secured or is secured in the closed position, in particular in a form-fitting manner. For example, the lock element can be moved relative to a base element of the lock and in particular relative to the locking element between a locking position and an unlocking position, in particular translationally and/or rotationally. In the closed position of the vehicle door and in the locking position of the lock element, the lock element interacts with the locking element, in particular in a form-fitting manner, as a result of which the vehicle door is to be secured or is secured in the closed position. By or when unlocking the lock, for example, the lock element is moved from the locking position to the unlocking position, in which the lock element does not interact with the locking element. As a result of this, the vehicle door is released for a movement from the closed position to the open position relative to the structure. If, for example, the vehicle door is in the closed position and, for example, the lock element interacts with the locking element, in particular in a form-fitting manner, and the lock is then locked, in particular by operating, in particular activating, the operating element, for example, a securing element is moved from a release position to a securing position, in particular relative to the lock element and/or relative to the locking element. In the release position, for example, the securing element releases the lock element for a movement of the lock element from the locking position to the unlocking position, so that in the release position of the securing element, the lock element can be moved from the locking position to the unlocking position and the vehicle door can subsequently be opened. In the securing position, for example, the securing element interacts with the lock element, in particular in a form-fitting manner, as a result of which, for example, the lock element is secured, in particular in a form-fitting manner, against a movement of the lock element from the locking position to the unlocking position. Thus, for example, the lock element can be moved from the locking position to the unlocking position if, and in particular only if, in particular previously, the securing element is or has been moved from the securing position to the release position, in particular translationally and/or rotationally, thus if, in particular previously, the lock is or has been unlocked.

The operating element can be, for example, a mechanical operating element such as, for example, a knob, a button or a key, so that the operating element can be moved, for example, relative to the handle element and/or relative to the base mentioned between a starting position and an operating position, in particular translationally and/or rotationally. By operating, in particular actuating, the operating element, the operating element is moved, for example, from the starting position relative to the handle element and/or relative to the base into the operating position, as a result of which the lock can be electrically unlocked and/or electrically locked, thus as a result of which an electrical unlocking and/or an electrical locking of a lock can be brought about. It is furthermore conceivable that the operating element is formed as a touch-sensitive surface or comprises a touch-sensitive surface, wherein the operating element is operated, i.e. should be operated, by touching the touch-sensitive surface. It is furthermore conceivable that the operating element is an electronic component or comprises at least or exactly one electronic component. It is furthermore conceivable that the operating element is formed to detect an approach of a person, i.e. for example an approach of a body part such as, for example, a finger of a person to the operating element, in particular without contact, i.e. without contact between the person and the operating element, as a result of which the operating element can be operated in particular without contact, i.e. without the person touching the operating element. Thus, for example, the lock can be electrically unlocked and/or electrically locked by the aforementioned approach, in particular without contact, i.e. in particular without the person touching the operating element. The electronic component is thus, for example, a proximity sensor, by way of which the aforementioned approach is detected. Alternatively or additionally, the electronic component can be a touch sensor which can detect the aforementioned touch of the touch-sensitive surface, wherein the touch sensor can, for example, comprise the touch-sensitive surface. Furthermore, it is in particular conceivable that the operating element is or can be operated in particular only by touching the touch-sensitive surface, i.e. when and preferably only when a person touches the touch-sensitive surface with their finger, for example.

The feature that the lock can be electrically unlocked and/or electrically locked by operating, in particular actuating, the operating element is to be understood in particular as meaning that, for example, as a result of operating the operating element, an electrically operable actuator, in particular an electric motor, is actuated, in particular electrically. By actuating the actuator, the actuator is operated electrically, so that by way of the actuator, for example, the lock element is moved, in particular using electrical energy and thus electrically, from the locking position to the unlocking position and/or from the unlocking position to the locking position. Alternatively or additionally, it is conceivable that the actuator is operated electrically by actuating the actuator, so that by way of the actuator, for example, the aforementioned securing element is moved from the securing position to the release position and/or from the release position to the securing position, in particular using electrical energy and thus electrically. This means that, for example, the lock element is moved electrically from the locking position to the unlocking position and/or from the unlocking position to the locking position, as a result of which the lock element is unlocked or locked electrically, i.e. using the aforementioned electrical energy. Alternatively or additionally, for example, the securing element is moved electrically from the securing position to the release position and/or from the release position to the securing position, as a result of which the lock is unlocked or locked electrically, i.e. using the aforementioned electrical energy. A movement of the vehicle door from the closed position to the open position following the electrical unlocking of the lock can then be effected manually by the person in the vicinity, for example, in particular by the person manually exerting a force, in particular a tensile force, on the handle element and thus moving the vehicle door relative to the structure from the closed position to the open position. Furthermore, it is conceivable that as a result of operating the operating element, in particular as a result of electrically unlocking the lock, the vehicle door is movable or is moved electrically, i.e. using electrical energy, from the closed position to the open position relative to the structure, in particular by unlocking the lock, in particular electrically. For this purpose, for example, an electrically operable movement apparatus is provided, which, for example, has the aforementioned electrically operable actuator and/or at least one further electrically operable actuator. As a result of operating the operating element and in particular as a result of unlocking the lock, for example, the movement apparatus is actuated, in particular electrically, as a result of which the movement apparatus, for example, moves, in particular pivots, the vehicle door using electrical energy and thus electrically relative to the structure from the closed position to the open position. The lock can thus be unlocked or locked particularly conveniently, and the vehicle door can be opened or locked particularly conveniently. Alternatively or additionally, it is conceivable that, for example, as a result of the operation of the operating element, the movement apparatus is actuated, in particular electrically, as a result of which the movement apparatus moves the vehicle door, which is initially in the open position, using electrical energy and thus electrically relative to the structure from the open position to the closed position, in particular pivots it, whereupon, for example, the lock is locked, in particular electrically, that is, for example, the lock element is moved electrically from the unlocking position to the locking position and/or the securing element is moved electrically from the release position to the securing position.

Alternatively or additionally, at least one or exactly one gesture sensor is integrated into the handle element, by way of which at least one gesture of a person, such as, for example, the person in the surroundings, can be detected. As a result of the detection of the gesture, for example, at least one function of the vehicle door, in particular of the lock, and/or of the vehicle can be carried out, i.e. moved or performed. For example, it is conceivable to electrically unlock and/or electrically lock the lock, in particular in the manner described above, as a result of the detection of the gesture. This allows a particularly simple, convenient and advantageous operation of the vehicle door to be represented. For example, the gesture sensor is or comprises at least one or exactly one electronic component.

Alternatively or additionally, at least one voice recognition sensor is integrated into the handle element, by way of which at least one voice command uttered acoustically, i.e. spoken, by a person, such as the person in the vicinity, can be detected. For example, the voice recognition sensor is or comprises at least or exactly one electronic component. As a result of the detection of the voice command, for example, at least one function of the vehicle door, in particular the lock, and/or the vehicle can be carried out, i.e. effected. For example, as a result of the detection of the voice command, the lock can be electrically locked and/or electrically unlocked, in particular in the manner described above.

Alternatively or additionally, at least one near-field communication sensor is integrated into the handle element, which is also referred to as an NFC sensor (NFC-Near Field Communication). In particular, the near-field communication sensor is or comprises at least one electronic component. The near-field communication sensor is formed for near field communication (NSC). Near field communication (NFC-Near Field Communication) is an international transmission standard based on RFID technology for the contactless exchange of data by electromagnetic induction using, in particular, loosely coupled coils over short distances of a few centimeters and, for example, a data transmission rate of a maximum of 424 kilobits per second.

In order to be able to realize particularly advantageous operation, in particular actuation of a vehicle door, in a particularly installation space-efficient manner, it is provided in the case of one embodiment of the disclosure that at least or exactly one circuit, also referred to as a printed circuit board, circuit card or printed circuit, is arranged in the handle element, on which circuit the at least one operating element and/or at least one gesture sensor and/or at least one voice recognition sensor and/or at least one near-field communication sensor, thus the respective aforementioned electronic component, is arranged. Thus, the at least one operating element, the at least one gesture sensor, the at least one voice recognition sensor and/or the at least one near-field communication sensor, thus the respective aforementioned component, is carried by the circuit board. This can ensure a particularly advantageous and installation space-efficient integration of functional elements or functions into the handle element.

In order to be able to operate the vehicle door particularly advantageously, it is provided in a further configuration of the disclosure that the handle element has an outer skin that can be perceived visually and haptically by the person in the surroundings of the vehicle door, in particular of the motor vehicle as a whole. The outer skin of the handle element is also referred to as the handle element outer skin. In other words, the person in the surroundings can see the outer skin with their eyes and thus perceive it visually, and the person in the surroundings can, for example, directly touch the outer skin with their hand, in particular with their fingers, and thus perceive it haptically, in particular when the vehicle door and in particular the motor vehicle as a whole are fully manufactured. The outer skin is thus a surface of the handle element that can be perceived visually and haptically by the person in the surroundings, or is formed by such a surface. In this case, it is in particular conceivable that the aforementioned touch-sensitive surface is a part of the handle element outer skin, also referred to as the detection part. In particular, it is conceivable that the vehicle door as a whole has an outer skin that is visually and haptically perceptible by the person in the surroundings, also referred to as the overall outer skin, wherein the previous and following statements in relation the handle element outer skin can also be easily transferred to the overall outer skin and vice versa. In this case, the handle element outer skin is in particular a first part of the overall outer skin. For example, the vehicle door has a shell, also referred to as a door shell, wherein it is conceivable, in particular in the fully manufactured state of the motor vehicle, that the vehicle door is to be held or is held on the structure of the motor vehicle so that it can be moved, in particular pivoted, via the shell. In other words, for example, the vehicle door is to be held or is held on the structure so that it can be moved, in particular pivoted, via the shell. For this purpose, it is provided, for example, that the vehicle door has at least one first hinge part, which is, for example, at least indirectly, in particular directly, attached, in particular fixed, to the shell. The first hinge part is, for example, a component of a hinge, also referred to as a door hinge, which also has a second hinge part, which is in particular formed separately from the first hinge part. The second hinge part is or can be attached at least indirectly, in particular directly, to the structure of the motor vehicle, in particular to the aforementioned vehicle pillar. The hinge parts are connected or connectable to one another in a movable, in particular pivotable, manner so that the shell is capable of being arranged or is arranged in a movable, in particular pivotable, manner on the structure via the hinge and the vehicle door as a whole can be moved, in particular pivoted, arranged or arranged on the body, i.e. can be held or held. For example, the shell is at least partially made of a metallic material. In this case, it is in particular conceivable that the shell is a component of a base body of the vehicle door. It is furthermore conceivable that the vehicle door, in particular the base body, has at least one outer paneling element, also simply referred to as a paneling element. For example, the outer paneling element is formed separately from the shell and is attached to the shell, in particular directly. The outer paneling element is also referred to as door cladding or door outer cladding. At least one region of the shell is covered and thus clad by the outer paneling element, in particular with respect to the closed position of the vehicle door and in the installation position of the vehicle door to the surroundings and thus toward the outside, i.e. in a direction pointing away from the interior of the motor vehicle. In this case, for example, the outer paneling element has an outer skin, also referred to as the paneling outer skin, wherein the previous and following statements in relation to the handle element outer skin and the overall outer skin can also be easily transferred to the paneling outer skin and vice versa. In this case, for example, the paneling outer skin is or forms a second part of the overall outer skin of the vehicle door. In particular, it is conceivable that at least part of the outer paneling element and thus of the paneling outer skin adjoins the stated windowpane opening and/or the door sill downward in the installation position of the vehicle door and in particular in the closed position of the vehicle door in the vertical direction of the motor vehicle.

In order to be able to realize particularly advantageous operation, in particular actuation, of the vehicle door, it is advantageously provided that the handle element has a first sub-region forming a first part of the handle element outer skin, also referred to as the first body part, which has a first direction of extent and thus extends along the first direction of extent. It is conceivable that the first sub-region protrudes from the base body in or along the first direction of extent. The first direction of extent is also referred to as the first direction. In the installation position of the vehicle door and in the closed position of the vehicle door, for example, the first direction runs in the transverse direction of the vehicle, in particular outward and thus toward the surroundings. It is thus preferably provided that the first sub-region protrudes in the first direction from the base body, in particular from the paneling element.

Furthermore, the handle element preferably has a second sub-region, also referred to as a second body part, which forms the second part of the handle element outer skin. The second sub-region of the handle element adjoins the first sub-region of the handle element, in particular an end of the first sub-region of the handle element facing away from the base body, wherein the second sub-region of the handle element protrudes from the first sub-region of the handle element in a second direction of extent, which is also referred to as the second direction and runs obliquely or perpendicularly to the first direction of extent (first direction). As a result, for example, the second sub-region is spaced apart from the base body and arranged in at least partial overlap with the base body. In particular, the second sub-region extends along the second direction of extent. In the installation position of the vehicle door and in relation to the closed position of the vehicle door, for example, the second direction (second direction of extent) runs upward in the vertical direction of the vehicle. For example, in the installation position of the vehicle door and in relation to the closed position of the vehicle door, the second sub-region of the handle element is overlapped inward in the transverse direction of the vehicle and thus toward the interior by the base body and thus, for example, by a part of the paneling outer skin. As a result, for example, the person in the surroundings can grasp the handle element, in particular the second sub-region of the handle element, with their hand in a particularly advantageous and ergonomic manner, in particular by reaching behind it, in particular in such a way that, for example, the person can move at least one of their fingers or several of their fingers between the second sub-region of the handle element and the base body. The person can then exert a force on the handle element in a particularly advantageous manner in order to handle the vehicle door in a particularly advantageous manner, i.e. in particular to be able to move it relative to the structure, in particular to pivot it.

For example, the gesture can be detected if the person performs the gesture on a side facing away from the base body and/or on a side of the handle element, in particular the second sub-region, facing the base body. In other words, the person can, for example, perform the gesture between the second sub-region and the base body and thus on the side of the handle element, in particular the second sub-region, facing the base body, wherein the gesture can subsequently be detected, for example, by way of the gesture sensor. In particular, a gesture is to be understood as at least one movement of at least part of the person along a predetermined or predeterminable movement path, so that, for example, the gesture can be detected or is detected without the person touching the handle element.

In order to be able to realize a haptically particularly advantageous and in particular ergonomic and convenient operation, in particular actuation, of the vehicle door, it is provided in a further configuration of the disclosure that, due to the fact that the second sub-region protrudes from the first sub-region in the second direction of extent, the handle element, in particular overall and thus viewed as a whole, is formed to be L-shaped or V-shaped and thus has an L-shape or a V-shape. Here, the sub-regions of the handle element form the L-shape or the V-shape, wherein the sub-regions of the handle element are respective legs of the L-shape or the V-shape. In particular, it is provided that the handle element is connected to the base body via the first sub-regions of the handle element.

In particular, the base body has an outer skin, also referred to as the base body outer skin, wherein the previous and following statements in relation to the handle element outer skin, the overall outer skin and the paneling outer skin can also be easily transferred to the base body outer skin and vice versa. At least part of the base body outer skin is the paneling outer skin or is formed by the paneling outer skin. Thus, the base body outer skin is part of the overall outer skin of the vehicle door. In particular, it can be provided that the first sub-region of the handle element protrudes in the first direction (first direction of extent) from the base body outer skin, in particular in the installation position of the vehicle door and in the closed position of the vehicle door towards the surroundings and thus away from the interior. This can ensure a particularly advantageous, in particular a particularly ergonomic and convenient, actuation and thus operation of the vehicle door.

In order to be able to realize a particularly advantageous range of function achievement and thus particularly advantageous operation of the vehicle door in a particularly installation space-saving manner, it is provided in a further configuration of the disclosure that the circuit board is arranged at least partially, in particular at least predominantly and thus by more than half or completely, in the first sub-region and/or in the second sub-region.

A further embodiment is characterized in that the operating element is formed to detect an approach of a person such as, for example, the above-mentioned person in the surroundings to at least one region of the handle element and, as a result of the detection of the approach, to bring about the electrical unlocking and/or locking, in particular without the person touching the at least one region. This allows, for example, a contactless unlocking and/or locking of the lock.

A further embodiment is characterized in that the operating element is formed to detect a person touching at least one contact region of the handle element and, in particular first or only as a result of detecting the touch, to electrically unlock and/or lock the lock. For example, the contact region is the touch-sensitive surface. This allows, for example, the person to electrically unlock and/or lock the lock by, and preferably only by, touching the contact region with one of their fingers, for example. As a result of this, particularly advantageous operation can be ensured.

A second aspect of the disclosure relates to a motor vehicle, also referred to as a vehicle or motor vehicle, preferably formed as a passenger motor vehicle, which has at least one vehicle door according to the first aspect of the disclosure. Advantages and advantageous configurations of the first aspect of the disclosure are to be regarded as advantages and advantageous configurations of the second aspect of the disclosure and vice versa.

### BRIEF DESCRIPTION OF THE DRAWING

Further details of the disclosure will become apparent from the following description of a preferred exemplary embodiment with the associated drawing.

FIG. 1 shows a detail of a schematic perspective view of a vehicle formed as a motor vehicle, in particular as a passenger motor vehicle and also referred to as a motor vehicle, with a vehicle door.

### DETAILED DESCRIPTION OF THE DRAWING

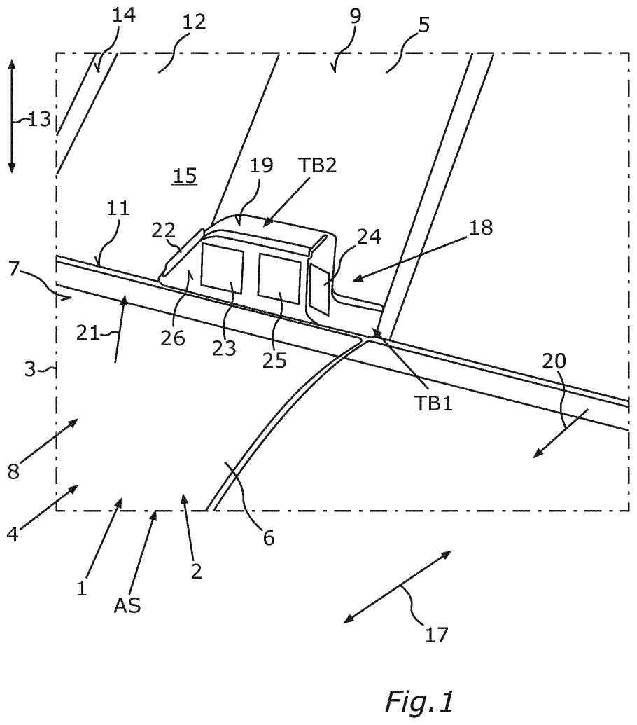

FIG. 1 shows a detail of a schematic perspective view of a motor vehicle 1, which is formed in the present case as a passenger motor vehicle and is also referred to as a motor vehicle or vehicle, the interior of which, also referred to as a passenger cabin or passenger compartment, is formed by a structure of the motor vehicle I formed in particular as a self-supporting body. The motor vehicle 1 has at least one vehicle door 2, which is also simply referred to as a door. The vehicle door 2 is a wing element, which is formed as the vehicle door 2 in the present case. The vehicle door is also simply referred to as a door and is a side door in the present case. The vehicle door 2 is assigned a structure opening of the structure, wherein the structure opening in the exemplary embodiment shown in FIG. 1 is formed as a side door opening of the structure. The vehicle door 2 is held, thus arranged, on the structure so that it can be moved, in particular pivoted, between a closed position and at least one open position relative to the structure. In the closed position, at least one sub-region of the structure opening is closed by the vehicle door 2. In the open position, the vehicle door 2 releases at least the sub-region of the structure opening, so that, for example, a person who is initially in the surroundings 3 of the motor vehicle 1 and then using the vehicle door 2 can enter the interior via the released sub-region of the structure opening. Furthermore, for example, the person who is initially in the interior can exit the interior via the released sub-region of the structure opening and thus reach the surroundings 3.

The vehicle door 2 has a base body 4, also referred to as a base body or door body, which has a shell, also referred to as a door shell and which is not visible in FIG. 1. The shell holds the vehicle door 2 on the structure of the motor vehicle 1 so that it can be moved, in particular pivoted. The base body 4 has at least one outer paneling element 6, also referred to simply as a paneling element, which is formed separately from the shell and, in particular, is connected directly to the shell. The outer paneling element 6 is also referred to as door cladding or door outer cladding. At least a first region of the shell is covered and thus clad by the outer paneling element 6, in particular in relation to the closed position of the vehicle door 2 toward the surroundings 3 and thus toward the outside, thus in a direction pointing away from the interior. It is apparent from FIG. 1 that the vehicle door 2 has a cladding element 5, which is formed separately from the outer paneling element 6, for example. For example, the cladding element 5 is held at least indirectly, in particular directly, on the shell. In particular, it is conceivable that at least a second region of the shell overlaps and is thus covered, i.e. clad, by the cladding element 5, at least in relation to the closed position of the vehicle door 2, with respect to the surroundings 3 and thus to the outside. The vehicle door 2 has an outer skin, also referred to as the overall outer skin 7, which can be perceived visually and haptically by the person in the surroundings 3 in the closed position of the vehicle door 2 shown in FIG. 1. A first part of the overall outer skin 7 is formed by an outer skin of the outer paneling element 6, also referred to as the paneling outer skin 8. A second part of the overall outer skin 7 is formed by an outer skin of the cladding element 5, also referred to as the cladding outer skin 9. For example, the cladding element 5 is made of a plastic. For example, the cladding element 5 is formed as a cover, or the cladding element 5 is also referred to as a cover. In particular, it can be provided that by way of the cladding element 5 in the closed position of the vehicle door 2, a vehicle pillar of the structure, formed in particular as a B-pillar, is at least partially overlapped and thus clad in the vehicle transverse direction of the motor vehicle toward the outside and thus toward the surroundings 3, so that the cladding element 5 is also referred to as a B-pillar cover, for example.

It can be seen particularly well from FIG. 1 that the vehicle door 2 has a door sill 11, also referred to as a sill or window sill, which is also referred to as a kerb or forms a kerb of the motor vehicle 1. Furthermore, the vehicle door 2 comprises a side windowpane 12, also simply referred to as a windowpane, which can be displaced relative to the shell and relative to the outer paneling element 6, at least in relation to the closed position of the vehicle door 2 in the vehicle vertical direction of the motor vehicle 1. In particular, the base body 4 comprises, for example, the shell, the outer paneling element 6 and the cladding element 5. Furthermore, the base body 4 can comprise, for example, the side windowpane 12. It is conceivable that, for example, a third part of the overall outer skin 7 is formed by an outer skin of the side windowpane 12, also referred to as the windowpane outer skin 14. The vertical direction of the vehicle is illustrated by a double arrow 13. In particular, the side windowpane 12 can be moved, i.e. displaced, in particular translationally, at least in relation to the closed position of the vehicle door 2 in the vehicle vertical direction of the motor vehicle 1 between a closed position shown in FIG. 1 and an open position not shown relative to the shell and relative to the outer paneling element 6 and also relative to the cladding element 5. The opened position is also referred to as the windowpane open position and the closed position is also referred to as the windowpane closed position. A window region 15, also referred to as the windowpane region, is at least partially delimited by the door sill 11, in particular in the installation position of the vehicle door 2 and downward in the vehicle vertical direction of the motor vehicle 1. The installation position of the vehicle door 2 is shown in FIG. 1, wherein the vehicle door 2 assumes its installation position in the fully manufactured state of the motor vehicle 1 having the vehicle door 2. In the case of the exemplary embodiment shown in FIG. 1, the windowpane region (window region 15) is a window opening, also referred to as a windowpane opening, which can be delimited, for example, by a window frame of the vehicle door 2, wherein the window frame, for example, encompasses the door sill 11. In particular, for example, the window frame is a component of the base body 4. In the closed position, the side windowpane 12 is at least partially arranged in the window region 15, in particular such that the window opening is at least partially, in particular at least predominantly and thus at least by more than half or completely closed by the side windowpane 12. In particular, it is provided that in the closed position (windowpane closed position) of the side windowpane 12, the door sill 11 in the installation position of the vehicle door 2 adjoins the side windowpane 12 downward in the vertical direction of the vehicle, in particular with respect to the closed position of the vehicle door 2.

The vehicle door 2 has, for example, a shaft, also referred to as a windowpane shaft or window shaft, which is formed in the installation position of the vehicle door 2 and in the closed position of the vehicle door 2 in the transverse direction of the vehicle to the outside and thus toward the surroundings 3, in particular directly, by the shell and/or by the outer paneling element 6. In particular, the shaft is overlapped in the installation position of the vehicle door 2 and in the closed position of the vehicle door 2 in the vehicle transverse direction of the motor vehicle I to the outside and thus toward the surroundings 3 by the outer paneling element 6 and/or by the shell. The transverse direction of the vehicle is illustrated by a double arrow 17. In the windowpane open position of the side windowpane 12, a sub-region of the side windowpane 12, also referred to as the windowpane sub-region, is arranged in the shaft and thus in particular outside the window region 15, in particular such that the windowpane sub-region in the open position is arranged in the vehicle vertical direction of the motor vehicle 1 below the door sill 11 and also below the window region 15, in particular with respect to the installation position of the vehicle door 2 and with respect to the closed position of the vehicle door 2. In the closed position (windowpane closed position) of the side windowpane 12, the window sub-region is arranged outside the shaft and in the window region 15, in particular such that the windowpane sub-region is arranged above the door sill 11 in the vertical direction of the vehicle, in particular at least in relation to the installation position and the closed position of the vehicle door 2. In other words, in the windowpane closed position, the door sill 11 adjoins the sub-region downwards in the vertical direction of the vehicle. For example, in the closed position (windowpane closed position) of the side windowpane 12, the window region 15 or the windowpane opening is at least partially, in particular at least predominantly and thus by at least more than half or completely, closed by the windowpane sub-region.

The vehicle door 2 further has a handle element 18 on the outside of the door, which is also referred to as an outer handle or door outer handle. The handle element 18 is arranged in the installation position of the vehicle door 2 and in relation to the closed position of the vehicle door 2, in particular at least partially and very preferably at least predominantly or completely, in the vehicle vertical direction of the motor vehicle I above the door sill 11. The feature that the handle element 18 is arranged on the outside of the door or on the outside, and is therefore an outer handle element or handle element on the outside of the door, is to be understood as meaning that the handle element 18 is arranged on an outer side AS of the vehicle door 2, the outer side AS of which faces away from the interior and toward the surroundings 3 in the installation position of the vehicle door 2 and at least in the closed position of the vehicle door 2. The person in the surroundings 3 can, for example, grasp the handle element 18 with his or her hand and, in doing so, at least partially grasp around it and subsequently exert a force, in particular a tensile force, on the handle element 18 in order to open the initially closed vehicle door 2, for example, and thus move it from the closed position to the open position relative to the structure.

In order thus to be able to operate, in particular actuate, the vehicle door 2 in a particularly simple, in particular ergonomic and convenient manner, the handle element 18 has a first sub-region TB1, referred to as the first body region or first body part, with a first direction of extent, which is also referred to as the first direction and is illustrated in FIG. 1 by an arrow 20. The first sub-region TB1 extends along the first direction. In the exemplary embodiment shown in FIG. 1, it is provided that the first sub-region TB1 protrudes in the first direction (arrow 20) from the base body 4, in particular from the cladding element 5. In particular, the first direction runs in the installation position of the vehicle door 2 and in relation to the closed position of the vehicle door 2 in the transverse direction of the vehicle, in particular outward. The handle element 18 furthermore has a second sub-region TB2, which is also referred to as the second body region or second body part. The second sub-region TB2 protrudes from the first sub-region TB1 in a second direction of extent, which is also referred to as the second direction, illustrated in FIG. 1 by an arrow 21. The second sub-region TB2 extends along the second direction of extent. It can be seen from the arrows 20 and 21 that the first direction and the second direction run perpendicularly or obliquely to one another, wherein the second direction in the present case points upward in the vertical direction of the vehicle, in particular in the installation position of the vehicle door 2 and in relation to the closed position of the vehicle door 2. In particular, the second sub-region TB2 adjoins an end of the first sub-region TB1 facing away from the base body 4, in particular along the first direction, so that or as a result of which, in the case of the exemplary embodiment shown in FIG. 1, the handle element 18, in particular viewed as a whole, is formed to be L-shaped and thus, in particular viewed as a whole, has an L-shape. The L-shape is formed by the sub-regions TB1 and TB2. Thus, the handle element 18 in the case of the exemplary embodiment shown in FIG. 1 is formed to be L-shaped. The sub-regions TB1 and TB2 are respective legs of the L-shape, wherein the handle element 18 is connected to the base body 4, in particular to the shell, via the sub-region TB1. The sub-region TB2 adjoins the sub-region TB1, in particular in the present case in such a way that the sub-region TB2 adjoins an end of the first sub-region TB1 facing away from the base body 4, in particular along the first direction.

In order to thus be able to realize particularly advantageous operation of the vehicle door 2, at least one operating element 22 for electrically locking and/or unlocking a lock is integrated into the handle element 18, by way of which the vehicle door 2 is to be secured in the closed position relative to the structure. Alternatively or additionally, at least one gesture sensor 23 is integrated into the handle element 18, by way of which at least one gesture of the person in the surroundings 3 can be detected, in particular without the person touching the handle element 18. Alternatively or additionally, at least one voice recognition sensor 24 is integrated into the handle element 18, by way of which at least one person in the surroundings 3 has expressed something, i.e. a spoken voice command can be detected. Alternatively or additionally, at least one near-field communication sensor 25 (NFC sensor) is integrated into the handle element. The operating element 22, the gesture sensor 23, the voice recognition sensor 24 and the near-field communication sensor 25 are also referred to collectively as elements. In particular, the gesture sensor 23, the voice recognition sensor 24 and/or the near-field communication sensor 25 are or comprise at least or exactly one sensor, which can in particular be formed as an electronic component. Furthermore, it is conceivable that the operating element 22 comprises at least or exactly one sensor or is a sensor, which in particular can also be formed as an electronic component.

For example, at least one or exactly one circuit board is arranged in the handle element, on which circuit board the respective sensor, preferably the sensors, are arranged. Thus, the circuit board is preferably a circuit board common to the sensors, and thus to the electronic components, by which the sensors or the electronic components are carried.

The handle element 18 has an outer skin that can be perceived in a visual and tactile manner by the person in the surroundings 3 of the vehicle door 2, in particular of the motor vehicle 1 as a whole, also referred to as the handle element outer skin 19, by which, for example, a fourth overall outer skin 7 is formed, thus which is in particular a fourth part of the overall outer skin 7. A first part of the handle element outer skin 19 is formed by the first sub-SUBSTITUTE region TB1, and a second part of the handle element outer skin 19 is formed by the second sub-region TB2.

The elements are, for example, integrated at different points on the handle element 18, in particular separately, i.e. in particular spaced apart from one another. This makes it possible, for example, for the elements to be addressed, i.e. operated, in particular independently or separately from one another, so that, for example, when one of the elements is operated, another of the elements is not also operated. The operating element 22 is, for example, formed to detect an approach of the person to the operating element 22 and, as a result of the approach and in particular without the person touching the operating element 22 or the handle element 18 as a whole, to cause the lock to be unlocked or locked electrically. Furthermore, it is conceivable that the operating element 22 is formed to detect a touch of the operating element 22 by the person and to cause the electrical unlocking or locking of the lock when and preferably only when the person touches the operating element 22. For this purpose, for example, the person exerts a pressure force on the operating element 22, so that the person presses on the operating element 22, for example.

Since the elements are integrated into the handle element 18, and since the elements are or have electronic components, an electrification of the handle element 18, in particular a high electrification of the handle element 18, is provided, so that the handle element 18 is an electrified, in particular a highly electrified, highly compact operating interface that can be operated by the person. Operating the gesture sensor 23 is to be understood in particular as meaning that the person performs the gesture that is detected by the gesture sensor 23. As a result, for example, at least one function of the vehicle door 2 and/or the vehicle is brought about. Operating the voice recognition sensor 24 is to be understood, for example, as meaning that the person utters the voice command that is detected by the voice recognition sensor 24. As a result, for example, at least one function of the vehicle door 2 and/or the motor vehicle 1 is brought about. Thus, voice control of the vehicle door 2 and/or the motor vehicle I can be represented. Operating the near-field communication sensor 25 is to be understood, for example, as the person holding a communication element, which is formed separately from the handle element 18, in such proximity to the near-field communication sensor 25 that the communication element and the near-field communication sensor 25 can exchange data with each other via wireless data. As a result, for example, at least one function of the vehicle door 2 and/or the motor vehicle 1 can be brought about. The function includes, for example, the electrical unlocking and/or locking of the lock. In this way, for example, vehicle access can be achieved in a simple manner. Overall, it can be seen that a plurality of applications or functions can be integrated into the handle element 18.

In order for the gesture sensor 23 to detect and thus record the gesture, the gesture is carried out, for example, between the sub-region TB2 and the cladding element 5 or on an outer side 26 of the sub-region TB2 facing away from the cladding element 5 and thus away from the interior.

The respective function that can be brought about by operating the respective element includes, for example, the electrical unlocking and/or locking described above on the basis of the operating element 22, so that a particularly simple and convenient operation of the vehicle door 2 can be represented.

### LIST OF REFERENCE SIGNS

1 Motor vehicle
2 Vehicle body
3 Surroundings
4 Base body
5 Cladding element
6 Outer paneling element
7 Overall outer skin
8 Paneling outer skin
11 Door sill
12 Side windowpane
13 Double arrow
14 Windowpane outer skin
15 Window region
17 Double arrow
18 Handle element
19 Handle element outer skin
20 Arrow
21 Arrow
22 Operating element
23 Gesture sensor
24 Voice recognition sensor
25 Near-field communication sensor
26 Outer side
AS Outer side
TB1 First sub-region
TB2 Second sub-region

1.-8. (canceled)

9. A vehicle door for a motor vehicle, having a handle element on the outside of the door and arranged above a door sill of the vehicle door, the handle element integrally comprising:
at least one operating element for electrical locking and/or unlocking of a lock, by way of which the vehicle door is to be secured in the closed position; and/or
at least one gesture sensor, by way of which at least one gesture of a person can be detected; and/or
at least one voice recognition sensor, by way of which at least one voice command expressed by a person can be detected; and/or
at least one near-field communication sensor.

10. The vehicle door according to claim 9, wherein there is arranged in the handle element at least or precisely one circuit board on which the at least one operating element and/or the at least one gesture sensor and/or the at least one voice recognition sensor and/or the at least one near-field communication sensor is arranged.

11. The vehicle door according to claim 10, wherein the handle element comprises:
an outer skin which can be visually and haptically perceived by a person in the surroundings of the vehicle door;
a first sub-region, which forms a first part of the outer skin of the handle element, with a first direction of extent; and
a second sub-region, which forms a second part of the outer skin of the handle element, adjoins the first sub-region and projects from the first sub-region in at least one second direction of extent running obliquely or perpendicularly to the first direction of extent.

12. The vehicle door according to claim 11, wherein the second sub-region projects from the first sub-region in the second direction of extent, and the handle element is formed to be L-shaped or V-shaped.

13. The vehicle door according to claim 12, wherein the circuit board is arranged at least partially in the first sub-region and/or in the second sub-region.

14. The vehicle door according to claim 9, wherein the operating element is formed to detect an approach of a person to at least one region of the handle element and, as a result of the detection of the approach, to bring about the electrical unlocking and/or locking of the lock.

15. The vehicle door according to claim 9, wherein the operating element is formed to detect a person touching at least one touch region of the handle element and, as a result of the detection of the touch, bring about the electrical unlocking and/or locking of the lock.

16. A motor vehicle having at least one vehicle door according to claim 9.
